(19) United States
(12) Patent Application Publication
(10) Pub. No.: US 2006/0151598 A1
(43) Pub. Date: Jul. 13, 2006

(54) Categorization based spending control

(76) Inventors: Yen-Fu Chen, Austin, TX (US); John Hans Handy-Bosma, Cedar Park, TX (US); Keith Raymond Walker, Austin, TX (US); Thomas L. Watters, North Las Vegas, NV (US)

Correspondence Address: IBM CORP (YA);C/O YEE & ASSOCIATES PC, P.O. BOX 802333, DALLAS, TX, 75380, US

(21) Appl. No.: 11/034,683

(22) Filed: Jan. 13, 2005

(51) Int. Cl. G06K 5/00; G07F 19/00; G06Q 40/00

(52) U.S. Cl. 235/380; 235/379; 705/44

(57) ABSTRACT

A categorization based spending control at the time of purchase is provided. An account holder may establish spending limits for categories of products and/or services, and establish filter limits based on merchant location, time, and day. The merchant may be associated with a spending category. The merchant point of sale device may also encode categories and associated spending amounts into a text string, which is appended to the merchant identifier. When a transaction is initiated, the account provider receives a request for authorization. The account provider may then parse the merchant name, decode the text string, and compare each category and transaction amount to the established spending limits. If the purchase satisfies the established spending limits for each category and filter, then the transaction is approved.

### BACKGROUND OF THE INVENTION

1. Technical Field

The present invention relates to electronic transaction processing and, in particular, to credit card or debit card authorization and spending control. Still more particularly, the present invention provides a method, apparatus, and computer program product for categorization based credit card or debit card spending control.

2. Description of Related Art

Current banking transactions, such as credit card or debit card transactions, allow few spending controls. When a transaction is submitted for approval, the credit card processing system merely compares the transaction amount to an available balance, which may be a bank account balance, a prepaid account balance, or an available credit limit. If the transaction amount is within the available balance or limit, the transaction is approved.

Purchase accountability in parent-child or manager-employee relationships typically comes down to a manual review or audit of transactions after the fact, using a paper or electronic statement. Existing services allow an accountable authority to control the balance of a credit or debit card, but not where and how the balance may be used. Audits help; however, inappropriate purchases can be hidden or disguised.

Recently, solutions for spending control have been introduced. For example, many credit card companies provide prepaid cards. Parents or employers may load these cards to enforce spending limits. However, these cards are limited in their spending control. There is nothing to specify how the cards may be used. For instance, a college student may use a prepaid card intended for educational books and software to buy electronic games. An employee may use a prepaid card intended for meals for client development to buy drinks at happy hour.

Furthermore, many credit cards provide rewards and incentives for their use. Rewards and incentives have motivated many families to use these cards to make all monthly or weekly purchases, paying the majority of the balance off each billing cycle. The monthly billing statement may then be used as an audit for monthly spending. However, as mentioned above, this may not be used to control spending at the time of purchase.

### SUMMARY OF THE INVENTION

The present invention recognizes the disadvantages of the prior art and provides a categorization based spending control at the time of purchase. An account holder may establish spending limits for categories of products and/or services. When a transaction is initiated, the account provider receives a request for authorization, which includes an identification of the merchant. The merchant is associated with a spending category, and there are filters unrelated to the category such as merchant location, time, and day. If the transaction amount is within the spending limit for the category, taking into account filters, the transaction is approved; otherwise, the transaction is declined.

In another embodiment, the merchant point of sale device encodes categories and associated spending amounts into a text string. This text string is appended to the merchant identifier. When a transaction is initiated, the account provider receives a request for authorization. The account provider may then parse the merchant name, decode the text string, and compare each category and transaction amount to the established spending limits. If the purchase satisfies the established spending limits, then the transaction is approved.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a client data processing system in which the present invention may be implemented;

FIG. 4 is a block diagram illustrating a point of sale data processing system in which the present invention may be implemented;

FIGS. 5A and 5B illustrate a transaction processing system in accordance with an exemplary embodiment of the present invention;

FIGS. 6A and 6B illustrate a transaction processing system with encoded category information in accordance with an exemplary embodiment of the present invention;

FIG. 7 is an example screen of display of a user interface for setting categorization based spending limits in accordance with an exemplary embodiment of the present invention;

FIG. 8 is a flowchart illustrating the operation of a transaction approval system in accordance with an exemplary embodiment of the present invention;

FIG. 9 is a flowchart illustrating the operation of a point of sale system for appending categorization information for spending control in accordance with an exemplary embodiment of the present invention; and

FIG. 10 is a flowchart illustrating the operation of a transaction approval system with encoded category totals in accordance with an exemplary embodiment of the present invention.

### DETAILED DESCRIPTION OF THE PREFERRED EMBODIMENT

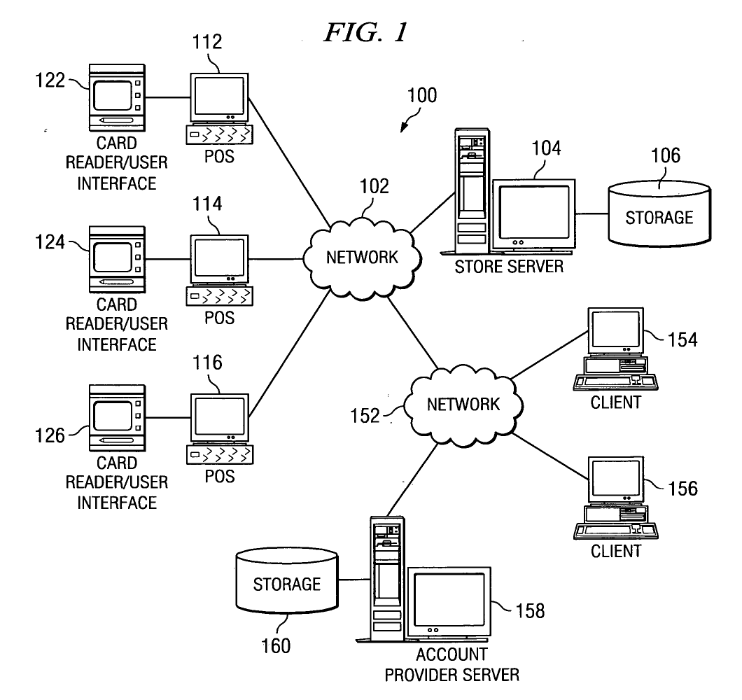

The present invention provides a method, apparatus and computer program product for categorization based spending control. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, store server 104 is connected to network 102 and provides access to storage unit 106. In addition, point of sale (POS) devices 112, 114, and 116 are connected to network 102. In the depicted example, store server 104 provides data, such as product information and customer information to POS devices 112-116. Store server 104 may also log transaction data and other data in storage 106 for batch processing or auditing. POS devices 112, 114, and 116 are clients to store server 104.

POS devices 112-116 are connected to card reader/user interface devices 122, 124, 126. Customers may use card reader/user interface devices 122-126 to effectuate transactions through POS devices 122-126. Customers may swipe a credit or debit card, approve/disapprove a transaction, and request cash back, for example, using card reader/user interface devices 122-126. POS devices 112-116 may be manned by a cashier or may be self-service checkout devices, in which case the customer may also enter product purchase information, such as item codes and the like, through card reader/user interface devices 122-126.

Network data processing system 100 also contains network 152, which is the medium used to provide communications links between various devices and computers connected together within network data processing system 100. Network 152 may include connections, such as wire, wireless communication links, or fiber optic cables. Account provider server 158 is connected to network 152 and provides access to storage unit 160. In addition, clients 154, 156 are connected to network 152. In the depicted example, account provider server 158 provides data, such as account balance information, to store server 104 and POS devices 112-116. Account provider server 158 may also log transaction data and other data in storage 160 for billing, fraud detection, and the like. Clients 154, 156 are clients to account provider server 158. Network data processing system 100 may include additional servers, clients, and other devices not shown.

An account holder, such as a parent, an employer, or simply a person who wishes to set a budget, accesses account provider server 158 using one of clients 154, 156. Account provider server 158 may provide a Web server application; however, the Web server may be provided by a separate data processing system. Through a Web based interface, a user at one of clients 154, 156 may set spending limits for particular categories. For example, a parent may limit a child to $50 for entertainment purchases, $100 for food, and $100 for books per month. As another example, an employer may limit an employee to $100 for restaurant dining for client development and $50 for office supplies per month. Alternatively, limits may be set as a percentage of an overall spending limit or credit limit. These categorization based spending limits may be stored in storage 160 for use in transaction approval/disapproval.

When a transaction, such as a credit or debit card transaction, is initiated, the POS device sends a request to account provider server 158, which includes a transaction approval system. The request may include a merchant identifier, which is typically a text string that includes at least a merchant name and sometimes includes a telephone number, address, or other information. Many credit card companies keep databases that associate merchant identification information with categories. For example, supermarkets are associated with groceries, movie theaters are associated with entertainment, clothing stores are associated with wearing apparel, and so forth. Account provider server 158 may then determine a category for the purchase from the transaction request and determine whether the transaction amount is within the spending limit for that category stored in storage 160. If the transaction amount is within the spending limit, then the transaction is approved; otherwise, the transaction is declined.

Some merchants, such as department stores and discount stores, may provide many categories of products and/or services. With the rise in popularity of discount super stores, it is highly likely that a purchaser may buy clothing, school supplies, groceries, DVD movies, alcoholic beverages, and prescription eyeglasses all in same retail establishment. In accordance with one embodiment of the present invention one or more of POS devices 114-116 may be modified to encode further category information in the approval request. The POS devices may itemize purchase amounts for each category, compress this data, and encode the data into text form to form a short text string. This short text string may then be appended to the merchant identification information, for example.

When the approval request is received at account provider server 158, the merchant identification information may be parsed for the text string, which may then be decoded and decompressed to form itemized category information and purchase amounts. Account provider server 158 may then approve or decline the transaction at the time of purchase based on the pre-established categorization based spending limits.

Filters may be applied regardless of merchant type, product type, and spending amounts. For example, if a parent wants their child to only be able to purchase products within a limited radius of their college campus, such as to prevent unauthorized trips, they may place spending controls upon merchant location relative to a fixed point. This could also prevent incurring debt by making online, phone, or mail order purchases.

Furthermore, time and day filters may be used. For example, as a means of accountability, a time restriction at bars or dance clubs can be used to help reduce the potential for drunk driving or staying out too late. A general time restriction at some point in the evening can discourage late night activity. Location and time control filters can be beneficial for limiting the amount of damage that could be done if the credit card were stolen.

In an alternative embodiment, transactions may be approved or declined by store server 104 before the transaction request is sent to the account provider server 158. For example, the account may be a store card. An account holder may also wish to limit spending based on categories only in particular retail establishments. Thus, categorization based spending limits may be established through store server 104 and stored in storage 106.

In the depicted example, network data processing system 100 is the Internet with network 102 and/or network 152 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

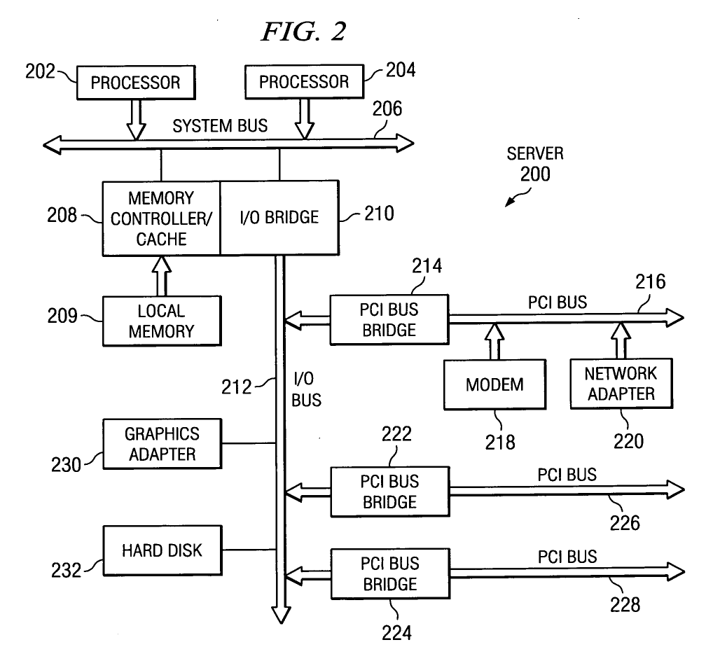

Referring to FIG. 2, a block diagram of a data: processing system that may be implemented as a server, such as store server 104 or account provider server 156 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

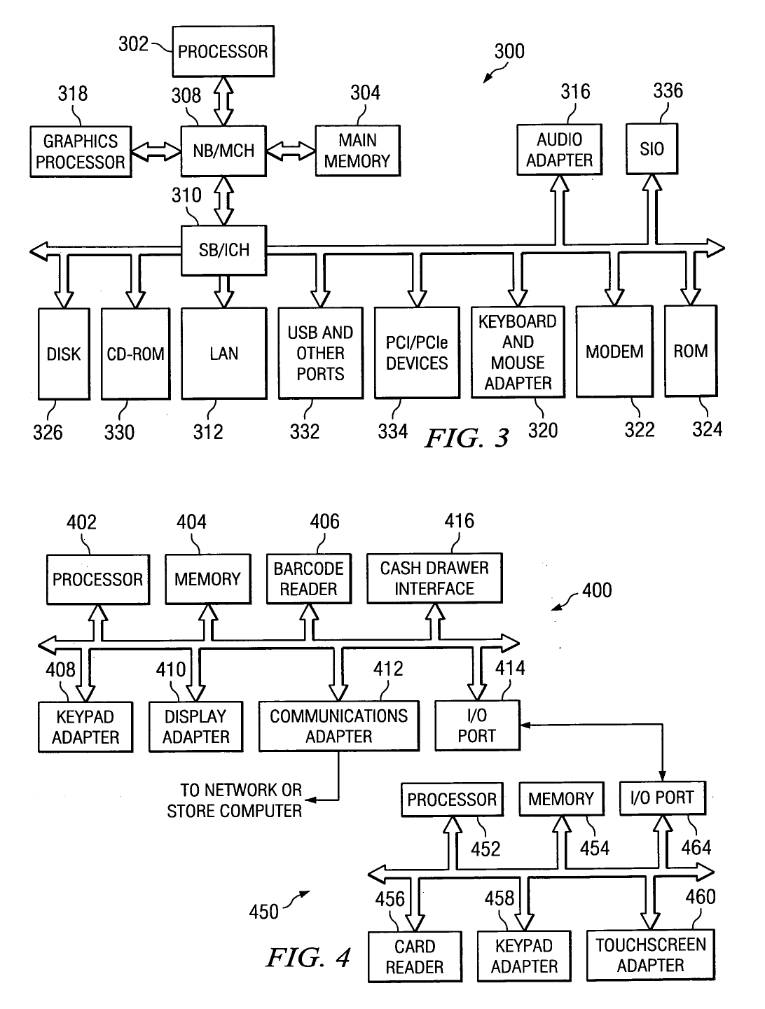

With reference now to FIG. 3, a block diagram of a data processing system is shown in which the present invention may be implemented. Data processing system 300 is an example of a computer, such as client 154 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICEH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

FIG. 4 is a block diagram illustrating a point of sale data processing system in which the present invention may be implemented. Point of sale (POS) device 400 includes processor 402, memory 404, barcode reader 406, keypad adapter 408, and display adapter 410. A cashier may scan products using barcode reader 406 and may enter other purchase information through keypad adapter 408. POS device 400 communicates with card reader/user interface 450 through I/O port 414. POS device 400 may also include cash drawer interface 416 for opening a cash drawer to accept cash payment or to give change or cash back, when requested.

Card reader/user interface 450 includes processor 452, memory 454, card reader 456, keypad adapter 458, and display adapter 460. A purchaser may swipe a credit or debit card using card reader 456 and enter purchase information through keypad adapter 458 and/or touchscreen adapter 460. Card reader 456 may be, for example, a magnetic stripe card reader or a smart card reader. For example, the purchaser may enter a personal identification number (PIN) for a credit or debit card, for example, through keypad adapter. The purchaser may also select Yes/No options for whether to proceed with the transaction or whether cash back is requested, for example, through touchscreen adapter 460. However, these functions may be performed through only keypad adapter 458, through only touchscreen adapter 460, or any combination thereof. Card reader/user interface 450 communicates with POS device 400 through I/O port 464.

The functional elements of POS device 400 and card reader/user interface 450 may be combined into a single data processing system. For example, a cashier may perform the card swipe and all other functions without interaction from the purchaser, who authorizes the transaction by signing a receipt. As another example, the POS data processing system may be a self-service checkout device, in which case the functional components may be combined into a single data processing system.

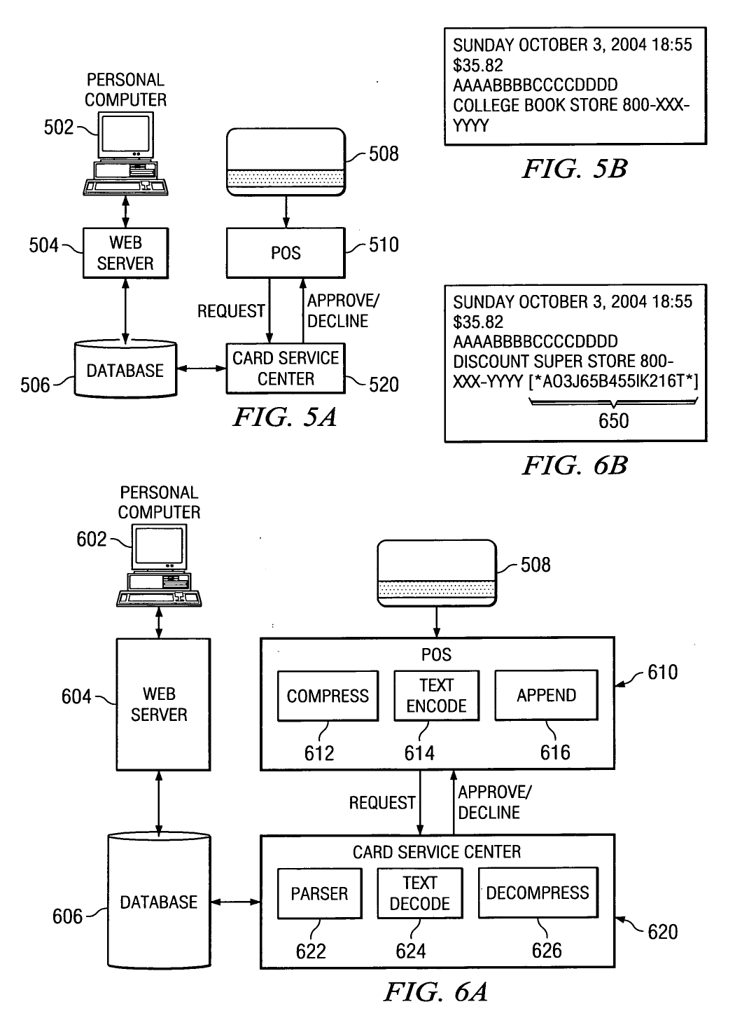

FIGS. 5A and 5B illustrate a transaction processing system in accordance with an exemplary embodiment of the present invention. More particularly, as shown in FIG. 5A, personal computer 502 communicates with Web server 504. A user establishes categorization based spending controls and limits through a user interface, such as a Web based interface. The spending controls may include, for example, an overall spending limit per period of time, such as a month or week, spending limits per category of purchase, or filter controls, such as location, time, and date filters. These categorization based spending limits and filter controls are stored in database 506 in association with the user's account, which may be a credit or debit card account, for example.

When card 508 is used at POS device 510, a transaction approval request is sent from POS device 510 to card service center computer 520. The transaction approval request may include, for example, a date, time, transaction amount, account number, and merchant identification information. An example of a transaction approval request is shown in FIG. 5B.

Card service center computer 520 receives the transaction approval request and provides a transaction approval system. In addition to categorization based spending limit information, database 506 also stores merchant identification information associated with predefined categories. Card service center computer 520 looks up the merchant information from the transaction approval request in database 506 to determine a category for the transaction.

Card service center computer 520 then determines whether the transaction amount for the transaction is within the spending limit for the category associated with the merchant for the account based on the spending limits stored in database 506. Then, based on this determination, card service center computer 520 sends an approve/decline message back to POS device 510.

FIGS. 6A and 6B illustrate a transaction processing system with encoded category information in accordance with an exemplary embodiment of the present invention. More particularly, as shown in FIG. 6A, personal computer 602 communicates with Web server 604. A user establishes categorization based spending controls and limits through a user interface, such as a Web based interface. These categorization based spending limits are stored in database 606 in association with the user's account, which may be a credit or debit card account, for example.

When card 608 is used at POS device 610 and a transaction is initiated, POS device 610 itemizes and categorizes the purchase items. POS device 610 then determines a purchase amount for each category and associates each category with the determined purchase amount for that category. This information is then compressed using compression module 612. The compressed category/amount information is then text encoded using text encode module 614 to form a text string. The text string is then appended to merchant identification information using append module 616. A transaction approval request including the appended category/amount information is sent from POS device 610 to card service center computer 620. Techniques for compression (e.g., zip, gzip, etc.) and text encoding (e.g., uuencode) are known in the art; however, specialized compression and/or text encoding techniques may be used that provide optimal results for category/amount information.

An example of a transaction approval request is shown in FIG. 6B. The transaction approval request may include, for example, a date, time, transaction amount, account number, and merchant identification information. In the example shown in FIG. 6B, the merchant identification information includes text string 650, which includes compressed and encoded category/amount information.

Card service center computer 620 receives the transaction approval request and provides a transaction approval system. Card service center computer 620 parses the merchant identification information portion of the transaction approval request using parser 622 to determine whether the request includes category/amount information. Predetermined characters may delineate this information, for example. In the example shown in FIG. 6B, encoded category/amount information is delineated by “[*” and “*]” characters; however, other characters may be used depending upon the implementation. Card service center computer 620 then decodes the category/amount information using text decode module 624 and decompresses the category/amount information using decompress module 626.

Card service center computer 620 then determines whether the transaction amounts for the categories are within the spending limits for the categories for the account based on the spending limits stored in database 606. Then, based on this determination, card service center computer 620 sends an approve/decline message back to POS device 610.

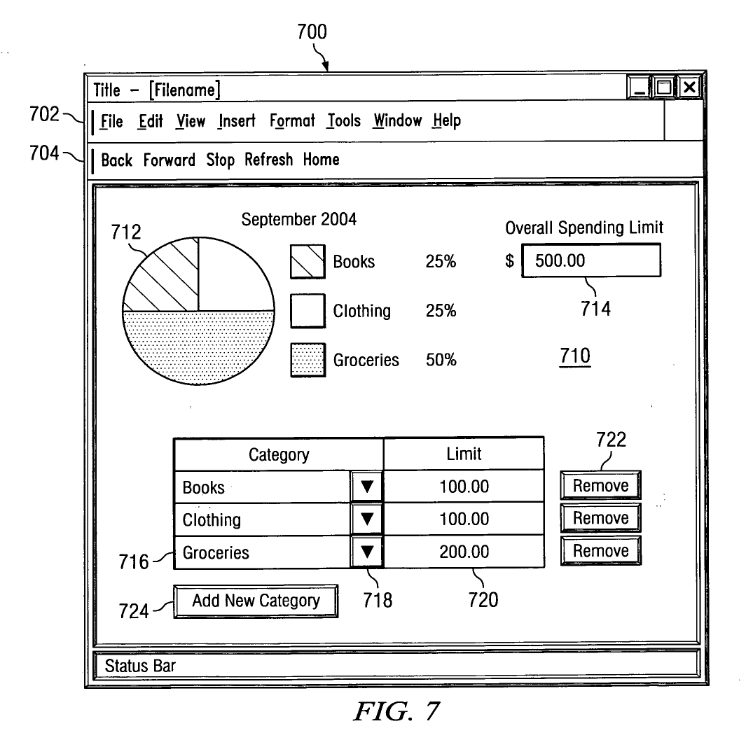

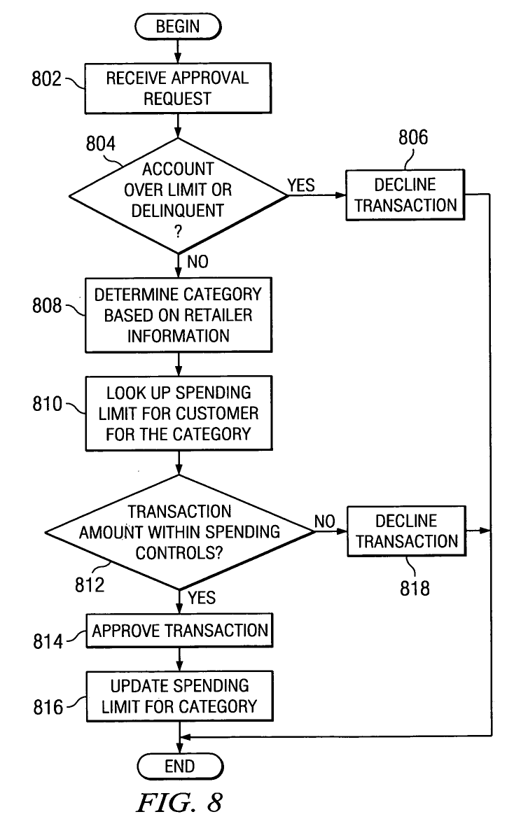

FIG. 7 is an example screen of display of a user interface for setting categorization based spending limits in accordance with an exemplary embodiment of the present invention. Window 700 may be, for example, a Web browser window. Window 700 includes menu bar 702 and button bar 704 for performing navigation, editing, and other Web browsing functions. Window 700 also includes display area 710, which presents the user interface.

Display area 710 presents categorization based spending history information for a previous month in area 712. In the depicted example, this history information includes a pie chart to illustrate categorization based spending patterns. Display area 710 also includes a control 714 for setting an overall spending limit.

Furthermore, display area 710 presents an interface for setting categorization based spending limits including category controls 716 for editing categories and limit controls 720 for setting spending limits for corresponding categories. Category controls 716 may include drop-down box controls 718 for selecting from a set of predefined categories. In the depicted example, spending limits are set in limit controls 720 using dollar amounts; however, other conventions may be used, such as percentage of overall spending limit.

The interface in display area 710 also includes remove control 722 for removing a particular category. Also, the interface in display area 710 includes add control 724 for adding a new category. The interface and controls shown in FIG. 7 are exemplary and are not intended to be limiting. Modifications may be made to the interface and controls depending upon the preferences of the interface designer or user. In fact, the interface may be customizable by the user.

FIG. 8 is a flowchart illustrating the operation of a transaction approval system in accordance with an exemplary embodiment of the present invention. Operation begins and the transaction approval system receives a transaction approval request (block 802). The transaction approval system determines whether the account is delinquent or goes over limit with the transaction (block 804). A credit card account may go over the limit, for example, if the transaction amount in the request is greater than an available credit amount. A debit card account or prepaid credit card account may go over the limit, for example, if the transaction amount in the request is greater than a current balance of the account. If the account goes over the limit or is delinquent, the transaction approval system declines the transaction (block 806) and operation ends.

If the account does not go over the limit and is not delinquent in block 804, the transaction approval system determines a category based on retailer or merchant identification information in the request (block 808), and filters based on location, time, and day. The transaction approval system then looks up a spending limit for the customer, identified by an account number in the request, and the category (block 810), taking into account filters.

Next, a determination is made as to whether the transaction amount is within the spending controls set for the category (block 812). The spending controls may include, for example, spending limits per time period or filter controls, such as location, time, and date filters. If the transaction amount is within the spending limit, the transaction approval system approves the transaction (block 814) and updates the spending limit information for the category based on the transaction amount (block 816). Thereafter, operation ends. If the transaction amount is not within the spending limit for the category, the transaction approval system declines the transaction (block 818) and operation ends.

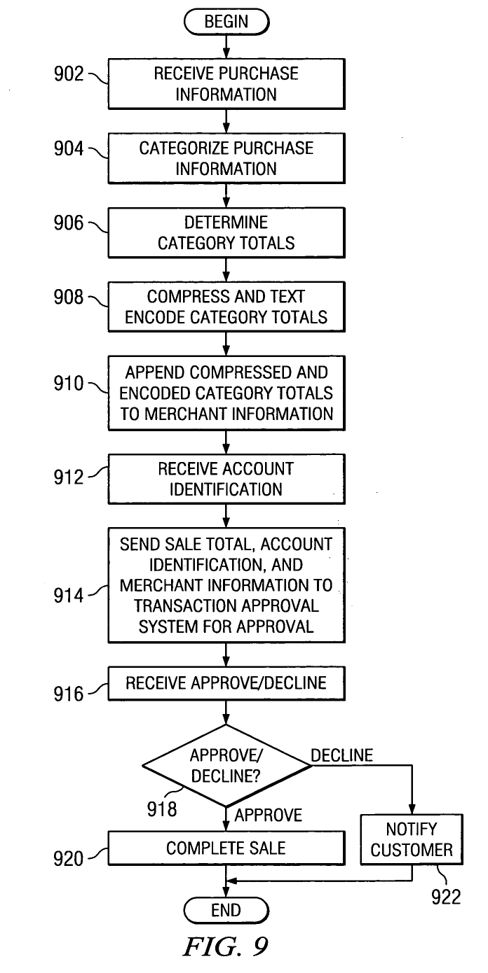

FIG. 9 is a flowchart illustrating the operation of a point of sale system for appending categorization information for spending control in accordance with an exemplary embodiment of the present invention. Operation begins and the point of sale system receives purchase information (block 902). The purchase information may include, for example, identification of products and/or services for purchase, discounts to be applied, and the like. The point of sale system then categorizes the purchase information (block 904) to form an itemized list of categories. Then, the point of sale system determines category totals (block 906).

Next, the point of sale system compresses and text encodes the category totals and category information (block 908) and appends the compressed and encoded category totals and category information to retailer or merchant information in a transaction approval request (block 910). The point of sale system then receives account identification information for the customer account (block 912). The customer account may be, for example, a credit card or debit card account number. Thereafter, the point of sale system sends a transaction approval request, including sale total, account identification, and merchant information, which has appended thereto the category total information, to a transaction approval system (block 914).

The point of sale system receives an approve/decline notification from the transaction approval system (block 916) and determines whether the transaction is approved or declined (block 918). If the transaction is approved, the point of sale system completes the sale (block 920) and operation ends. If, however, the transaction is declined in block 918, the point of sale system notifies the customer that the transaction is declined (block 922) and operation ends.

Thus, the point of sale system includes the functionality of appending category information into a transaction approval request. If the transaction approval system recognizes the category information in the request, then the transaction may be approved or declined using categorization based spending control. However, if the transaction approval system does not recognize the category information, it is simply ignored and the transaction information may be approved or declined based on the category of the merchant or based simply on the overall transaction amount.

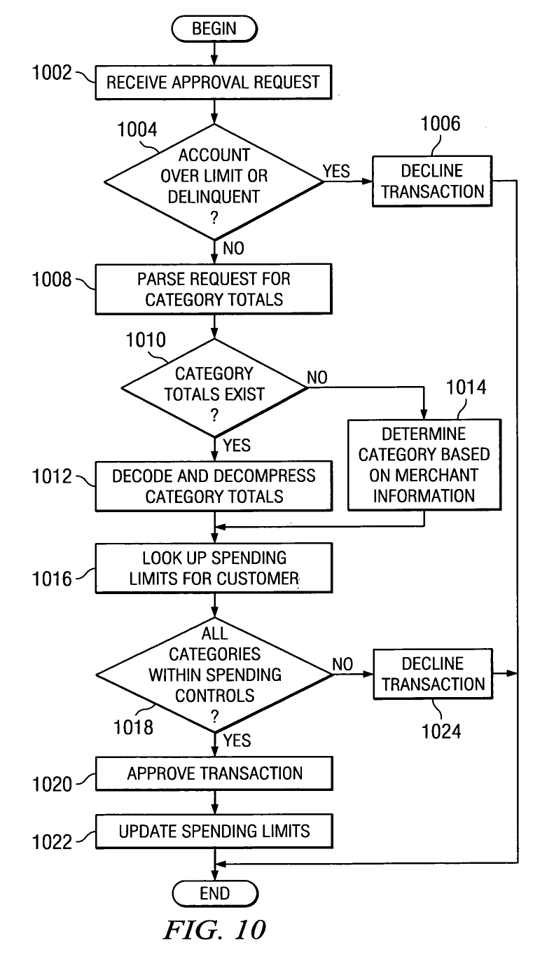

FIG. 10 is a flowchart illustrating the operation of a transaction approval system with encoded category totals in accordance with an exemplary embodiment of the present invention. Operation begins and the transaction approval system receives a transaction approval request (block 1002). The transaction approval system determines whether the account is delinquent or goes over limit with the transaction (block 1004). A credit card account may go over the limit, for example, if the transaction amount in the request is greater than an available credit amount. A debit card account or prepaid credit card account may go over the limit, for example, if the transaction amount in the request is greater than a current balance of the account. If the account goes over the limit or is delinquent, the transaction approval system declines the transaction (block 1006) and operation ends.

If the account does not go over the limit and is not delinquent in block 1004, the transaction approval system parses the transaction approval request for category totals information (block 1008). The category totals information may be encoded and appended into the merchant identification information in the transaction approval request. For example, the transaction approval system may parse for predetermined characters in the merchant identification information, which delineate the category totals information.

The transaction approval system determines whether category totals exist in the transaction approval request (block 1010). If the transaction approval request includes category totals information, the transaction approval system decodes and decompresses the category totals information (block 1012) and proceeds to block 1016. If the transaction approval request does not include category totals information in block 1010, the transaction approval system determines a category based on retailer or merchant identification information in the request (block 1014) and proceeds to block 1016.

In block 1016, the transaction approval system then looks up spending limits for the customer, identified by an account number in the request, for all identified categories. Next, filters are queried to determine if the time of day, the day, and the location of the merchant all allow for the transaction. Next, a determination is made as to whether the category totals are within the spending controls set for the categories (block 1018). The spending controls may include, for example, spending limits per time period or filter controls, such as location, time, and date filters. If the category totals are within the spending controls, the transaction approval system approves the transaction (block 1020) and updates the spending limit information for the categories based on the category totals or overall transaction amount (block 1022). Thereafter, operation ends. If the category amounts are not within the spending limits for the categories, the transaction approval system declines the transaction (block 1024) and operation ends.

Thus, the present invention solves the disadvantages of the prior art by providing categorization based spending controls that may be applied at the time of purchase. Parents, employers, and other accountable authorities may then control spending based on categories of items and services. The exemplary aspects of the present invention may apply to debit cards, credit cards, prepaid cards, and other accounts. For example, the exemplary aspects of the present invention may apply to prepaid gift cards or store cards. Categorization based spending controls may also be used to enforce a budget on one's self or family.

Furthermore, with categorization based spending control, a stolen card or account number is of less use to a thief. Categories may also be applied to particular stores, geographic locations, dates, days of the week, time of day, and other limitations on spending. The categorization based spending controls of the present invention also reduce fraudulent claim charges incurred by banks and other account providers.

Furthermore, it is apparent that categorization based spending control may be applied to gift cards or in lieu of gift cards. For example, a giver may be able to transfer or otherwise pay for money to be allocated to another person's account, and establish spending controls on that money, such as $50 at a local ice cream shop. This has benefits in not having to carry multiple gift cards, being able to precisely control the amount, participating in credit card rewards programs, and expanding gift cards to merchants who do not offer gift cards.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for transaction approval, the method comprising:
receiving spending control information from an account holder defining at least one spending control for an account;
receiving a transaction approval request for a transaction for the account, wherein the transaction approval request includes merchant identification information and an amount;
determining whether the transaction is within the at least one spending control for the account; and
declining the transaction if the transaction is not within the at least one spending control for the category or if filters do not allow the transaction.

2. The method of claim 1, wherein the at least one spending control includes one or more spending limits for one or more spending categories, the method further comprising:
identifying a transaction category for the transaction based on the merchant identification information,
wherein determining whether the transaction is within the at least one spending control includes determining whether the transaction is within a spending limit corresponding to the transaction category.

3. The method of claim 2, wherein identifying a transaction category for the transaction includes:
looking up the merchant identification information in a database; and
identifying a category associated with the merchant identification information.

4. The method of claim 1, wherein the at least one spending control includes one or more spending limits for one or more spending categories, the method further comprising:
parsing the transaction approval request for category information;
responsive to category information existing in the transaction approval request, decoding the category information to determine a plurality of category totals and corresponding categories.

5. The method of claim 4, wherein determining whether the transaction is within the at least one spending control includes determining whether the category totals are within spending limits for the corresponding categories.

6. The method of claim 1, wherein the at least one spending control includes at least one filter and wherein determining whether the transaction is within the at least one spending control for the account includes applying the at least one filter to the transaction.

7. The method of claim 1, wherein applying the at least one filter includes determining whether filters prohibit the transaction based on one of merchant location, time, and date.

8. A method, in a data processing system, for transaction approval, the method comprising:
receiving purchase information;
categorizing purchase information;
determining category totals for purchases;
text encoding the category totals and corresponding categories to form category information;
appending the category information to a transaction approval request; and
sending the transaction approval request to a transaction approval system.

9. The method of claim 8, further comprising:
compressing the category totals prior to text encoding the category totals.

10. The method of claim 8, wherein appending the category information includes delineating the category information with predetermined text characters.

11. The method of claim 8, wherein appending the category information includes appending the category information to merchant identification information in the transaction approval request.

12. A system for transaction approval, the system comprising:
a database that stores spending control information defining at least one spending control for an account; and
an account processing computer that receives a transaction approval request for a transaction for the account, wherein the transaction approval request includes merchant identification information and an amount; determines whether the transaction is within the at least one spending control for the account; and, declines the transaction if the transaction is not within the at least one spending control for the category or if filters do not allow the transaction.

13. The system of claim 12, wherein the at least one spending control includes one or more spending limits for one or more spending categories.

14. The system of claim 12, wherein the at least one spending control includes at least one transaction filter.

15. The system of claim 12, further comprising:
a Web server that presents a Web interface to an account holder, receives spending control information from the account holder through the Web interface, and stores the spending control information in the database.

16. The system of claim 12, wherein the account processing computer includes:
a parser module that parses the transaction approval request for category information; and
a text decoding module that decodes the category information to determine a plurality of category totals and corresponding categories.

17. The system of claim 12, further comprising:
a point of sale terminal that receives purchase information, categorizes purchase information, and determines category totals for purchases;
a text encoding module that text encodes the category totals and corresponding categories to form category information; and
an append module that appends the category information to a transaction approval request,
wherein the point of sale terminal sends the transaction approval request to a transaction approval system.
